(19) United States
(12) Patent Application Publication
(10) Pub. No.: US 2015/0082316 A1
(43) Pub. Date: Mar. 19, 2015

(54) System and Method for Efficient Utilization of Simulation Resources

(71) Applicant: evoleap, LLC, Houston, TX (US)

(72) Inventors: Michael Zaldivar, Houston, TX (US); Prasanna Venkatesh Parthasarathy, Sugar Land, TX (US)

(73) Assignee: evoleap, LLC, Houston, TX (US)

(21) Appl. No.: 14/029,895

(22) Filed: Sep. 18, 2013

(51) Int. Cl. G06F 9/48; G06F 9/50

(52) U.S. Cl. CPC G06F 9/4881; G06F 9/5005
USPC 718/103

(57) ABSTRACT

The present invention relates to automation of flow assurance simulation workflow using a web-based batch simulation scheduler. Further, the present invention relates to a system for efficient utilization of simulation resources comprising a database server; a simulator; a batch simulation scheduler; a license monitor; a launcher; a wrapper; and a debugger. The batch simulation scheduler schedules simulations on computing resources with specific input files based on user submitted information in database according to user-specified priorities. The license monitor updates the database with the number of available licenses for each feature or module. The launcher running on computing resources monitors the database for instructions from the scheduler to launch the simulations. The debugger parses the input file (s) and verifies its syntax without using a simulation license. The system utilizes all available licenses to execute the jobs thereby resulting in parallel execution of cases in the jobs.

### FIELD OF INVENTION

The present invention relates to flow assurance and particularly to automation of flow assurance simulation workflow using a web-based batch simulation scheduler. Further, the present invention relates to a system and method for scheduling a plurality of simulations from a plurality of users needing a plurality of resources. More particularly, the present invention relates to a system and method for efficient utilization of simulation software licenses in the field of flow assurance through the use of computerized simulation scheduling system.

### BACKGROUND ART

Flow assurance is a critical function in upstream oil and gas engineering. The purpose of flow assurance engineers is to ensure that the production facilities, typically in subsea environments, including pipelines, manifolds, jumpers and other subsea hardware are adequately designed so as to prevent any of several problems generally called “flow assurance problems” from occurring during the operation of said facilities. Common flow assurance problems include hydrate blockage, wax deposition, scale deposition, corrosion, erosion, slugging, liquid surge, and over pressurization. Because of the highly complex interacting physical phenomena that are involved in flow assurance problems, computer simulations of flow are generally the only way to assess if a particular design is suitable.

Upstream oil and gas industry has many simulation products that are used on a day-to-day basis for making engineering decisions. Few examples include reservoir simulators (Eclipse), pipeline simulators (LedaFlow, OLGA), process simulators (HYSYS, Aspen) and integrated production models (maximus). Simulation tools can be classified by the following characteristics (a) cost of licenses, (b) run times and (c) types of studies (parametric vs. single case).

Batch scheduling applications (schedulers) help users of simulators with the following characteristics, viz., (a) high license cost and therefore deployed as a shared multi-user resource, (b) run times of the order of a few hours to days and (c) used to run parametric studies.

Schedulers aim to automate the process of launching jobs. Some schedulers only allow for time or event-based scheduling of processes. These are typically targeted at IT users who want to run automated IT tasks such as backups. Another class of schedulers target high performance computing (HPC) users. They allow users to prepare input files, submit them to the scheduler, and are assured that the scheduler launch their simulations based on resource (typically computing resource) availability. The most important aspect of having automated schedulers is that they can work 24/7 while without them simulation resources (both licenses and computers) are idle during non-working hours (i.e., >75% of the time in a week).

Some class of simulators such as multiphase pipeline simulators (e.g., OLGA), pose additional problems since there are multiple modules that are licensed separately and generic schedulers are not designed to discern module license requirements for different jobs submitted by different users. Moreover, companies do not always have the same number of licenses for all modules and generic schedulers are typically not designed for this scenario either. HPC schedulers are designed to optimize the use of expensive computing resources (such as high performance clusters) rather than licenses.

Some of the prior arts are:

US20110224835 discloses a flow assurance system comprising a plurality of flow assurance devices, each for performing a different flow assurance function; a platform device for interfacing with the plurality of flow assurance devices to integrate the different flow assurance functions and enabling a single point of entry of data for the flow assurances devices of the system.
US20120317058 relates to method and expert system for risk assessment and safety management, more particularly, to a real-time method and system for detecting, predicting, assessing and managing risk events and providing Safety reliability of FPSO process and systems and managing information corresponding thereto to complex multifunctional process systems.
U.S. Pat. No. 5,247,677 relates to stochastic priority based scheduler for selecting executable tasks in a computer system. The stochastic priority based scheduler selects tasks on the basis of a random number weighted by task priority.
U.S. Pat. No. 6,941,514 relates to computerized scheduling systems to manage work order scheduling according to priority levels that are assigned to work order requests. The priority-based work order scheduling system includes a graphical user interface having displays for managing work orders stored in the system.
EP2245610 relates to method and system for automatically generating simulations for process control system checkout and operator training A programmed process model generator automatically incorporates a variety of process model data from pre-defined model libraries into descriptions of process equipment including control devices to render simulation models of various degrees of fidelity.

Accordingly, there exists a need for an automated system for scheduling and executing plurality of simulations according to user-specified priorities and a method for validating simulation inputs prior to submission to the queue in order to ensure that simulation resources are not wasted.

### OBJECTS OF INVENTION

Accordingly, it is the primary object of the present invention to provide automation of flow assurance simulation workflow using a web-based batch simulation scheduler system.

Another object of the present invention is directed to provide an automated system for scheduling a plurality of simulations from a plurality of users needing a plurality of resources.

It is another object of the present invention, wherein the automated system schedules a plurality of simulation jobs from a plurality of users incorporating a user-selectable priority for each simulation job.

It is another object of the present invention, wherein the automated system executes the simulations according to user-specified priorities.

A further object of the present invention is directed to provide a system and method for validating simulation inputs prior to submission to the queue, thereby ensuring that simulation resources are not wasted.

It is another object of the present invention, wherein the system tracks information about users' usage of the simulation software including metrics that can be used to assess the efficiency of users.

It is another object of the present invention, wherein the metrics include cases submitted, tracking of simulation times and execution-time parameters.

It is another object of the present invention, wherein the system utilizes all available licenses to execute the jobs thereby resulting in parallel execution of cases in the jobs.

It is another object of the present invention, wherein the system enables efficient sharing of expensive license resource among one or more users.

It is yet another object of the present invention to provide a method of debugging template input files.

It is further object of the present invention to provide a method of prioritization of simulation jobs for efficient utilization of simulation resources.

### SUMMARY OF INVENTION

Thus according to the basic aspect of the present invention there is provided a system for efficient utilization of simulation resources comprising:
a database server;
a simulator;
a batch simulation scheduler;
a license monitor;
a launcher;
a wrapper; and
a debugger,
wherein the batch simulation scheduler schedules simulations on computing resources with specific input files based on user submitted information in database according to user-specified priorities,
wherein the license monitor updates the database with the number of available licenses for each feature or module,
wherein the launcher running on computing resources monitors the database for instructions from the scheduler to launch the simulations,
wherein the debugger parses the input file(s) and verifies its syntax without using a simulation license, and
wherein the system utilizes all available licenses to execute the jobs thereby resulting in parallel execution of cases in the jobs.

It is another aspect of the present invention, wherein the system schedules a plurality of simulation jobs from a plurality of users incorporating a user-selectable priority for each simulation job.

It is another aspect of the present invention, wherein the system tracks information about users' activities and allows the users to create custom reports to extract specific information on license usage.

It is another aspect of the present invention, wherein the system tracks information about users' usage of the simulation including metrics that can be used to assess the efficiency of users.

It is another aspect of the present invention, wherein the metrics include cases submitted, tracking of simulation times and execution-time parameters.

It is another aspect of the present invention, wherein the system enables efficient sharing of expensive license resource among one or more users.

It is another aspect of the present invention, wherein the wrapper contains simulator-specific information about launching a simulation.

A further aspect of the present invention is directed to provide a method of efficient utilization of simulation resources using the system, comprising the steps of:
Preparing and submitting a template input file for a simulation job;
Launching the debugger;
Debugging the template input file;
Executing a single simulation based on the template;
Generating the input files required for a parametric study;
Ensuring all input variations and the input file has been correctly generated;
Allowing the users to submit a plurality of simulation jobs;
Allowing the user to monitor the status of each individual input file or case, in each job through web-based user interface;
Launching the input files;
Parsing the outputs of the simulator to identify if the input file is executing successfully or not;
User identifying failed cases by using filtering functionality on job status page;
User identifying reasons for failed cases by expanding the status for each of the failed cases; and
Rectifying the failure and resubmitting the failed cases, and
wherein the user can resubmit the failed cases without creating any new batch files or creating a new job.

A further aspect of the present invention is directed to provide a method of debugging the template input files, comprising the steps of:
Parsing an input file and verifying its syntax through algorithms that are specific to simulation program without using a simulation license;
Sending an error message specific to user's exact problem;
Monitoring the input file for changes after the error being fixed by the user;
Automatically triggering another validation for changed input file without user's request;
Launching a debug simulation to check for execution-time errors;
Starting the debugging process and streaming the output of the process back to its display window; and
Allowing the user to edit the input file based on errors at execution-time and launching a new debug job again,
wherein the debugging process is executed on the user's workstation.

It is another aspect of the present invention, wherein the user can estimate number of times an input file was modified and executed.

It is another aspect of the present invention, wherein the user is provided with a calculation of speed-up achieved by the simulation.

It is another aspect of the present invention, wherein the user is provided with minimum, maximum and average times taken by cases in a job.

A further aspect of the present invention is directed to provide a method of prioritization of simulation jobs for efficient utilization of simulation resources using the system, comprising the steps of:
Updating job prioritization, the job priorities comprising special priorities that include urgent, debug and background and normal priorities that include high, normal and low;
Checking for urgent jobs in queue;
Scanning for urgent jobs and cases required to execute the cases in the urgent jobs by the scheduler;
Selecting currently running simulations to kill to make through for urgent cases;
Force-killing the selected simulations and adding the associated cases back to the queue; and
Executing the cases from the urgent job queue.

It is another aspect of the present invention, wherein the cases to stop are selected in the following manner in order to allow running the urgent jobs:
Selecting the normal priority cases that are using the licenses required by the urgent job(s); and
Ordering the cases based on start time.

It is another aspect of the present invention, wherein once the urgent queue is cleared the other jobs are executed in the following manner:
Scanning for debug jobs after clearing the urgent cases; and
Executing the debug jobs first based on availability of free licenses.

It is another aspect of the present invention, wherein the scheduler executes background jobs when no other jobs with other priorities are in the queue.

It is another aspect of the present invention, wherein background cases to stop are selected in the following manner in order to run other jobs:
Selecting background priority cases that are using the licenses required by the other job(s); and
Ordering the cases based on start time.

It is another aspect of the present invention, wherein the scheduler allocates the simulation resources in the ratio 4:2:1 for the normal priorities.

It is another aspect of the present invention, wherein the scheduler calculates the ideal allocation of simulation resource to jobs according to their priorities.

It is another aspect of the present invention, wherein the scheduler keeps track of the actual allocation of simulation resource to active jobs.

It is another aspect of the present invention, wherein the scheduler selects the next case to run based on a forecasted allocation of simulation resource and its proximity to the ideal allocation of simulation resource.

It is another aspect of the present invention, wherein the scheduler calculates a balance-forward when the set of active jobs change so that relative allocation of simulation resources is always as close to the ideal allocation as possible.

### BRIEF DESCRIPTION OF THE ACCOMPANYING FLOWCHARTS/FIGURES

FIG. 1: illustrates the system for utilization of simulation resources according to prior art.

FIG. 2: illustrates the workflow followed by a flow assurance engineer in performing a simulation study according to prior art.

FIG. 3: illustrates a workflow between simulator, license manager and vendor daemon according to prior art.

FIG. 4: illustrates the steps involved in performing step (2) of FIG. 1 [Debugging Workflow] according to prior art.

FIG. 5: illustrates the system for efficient utilization of simulation resources according to the present invention.

FIG. 6: illustrates the steps for debugging workflow according to the present invention.

FIG. 7: illustrates the flow assurance workflow according to the present invention.

FIG. 8: illustrates prioritization function that fits the simulation workflow according to the present invention.

### DETAILED DESCRIPTION OF THE INVENTION WITH REFERENCE TO THE ACCOMPANYING FLOWCHARTS/FIGURES

The present invention as herein described relates to a system for efficient utilization of simulation resources. The automated system schedules a plurality of simulation jobs from a plurality of users incorporating a user-selectable priority for each simulation job. Further, the present invention relates to a system and method for validating simulation inputs prior to submission to the queue, through efficient use of simulation software licenses.

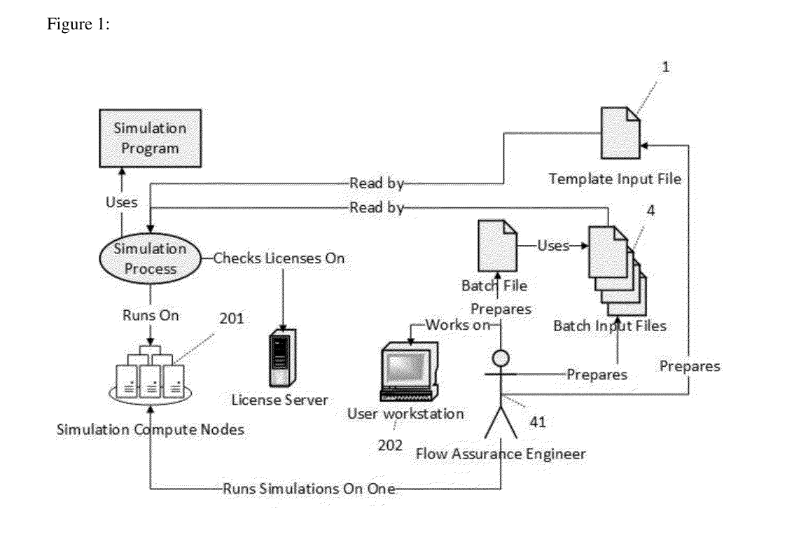

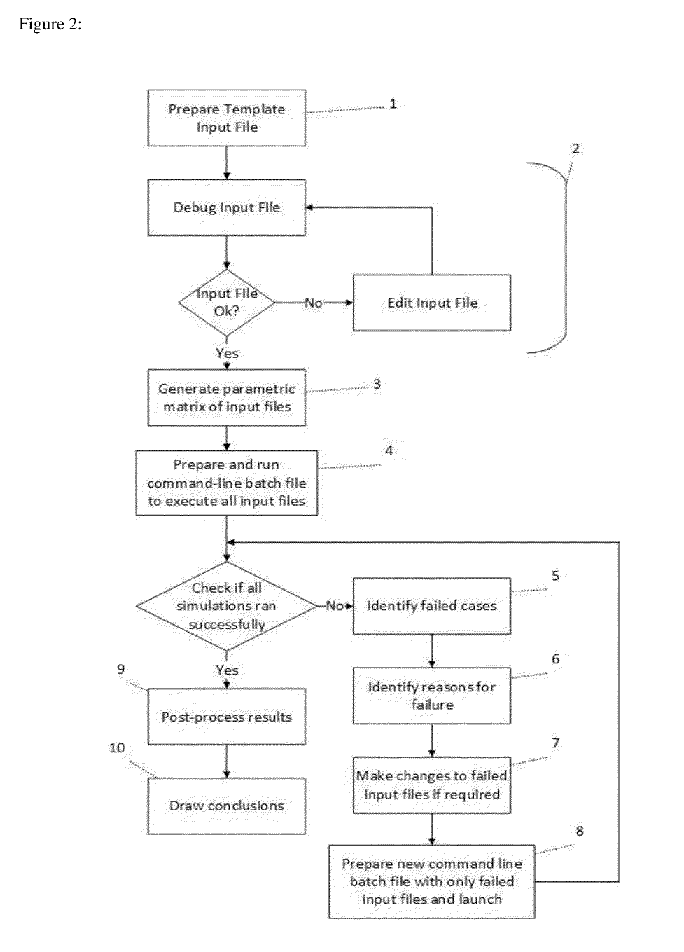

Reference is invited to FIG. 2 that illustrates the flow assurance workflow followed by a flow assurance engineer (41) in performing a simulation study using the system as illustrated in FIG. 1 according to prior art. A simulation study typically comprises of a plurality of simulations each based on a common pipeline network configuration but containing one or more variables that are different between the simulations. Typical examples of variables modified in a study include fluid characterization, pipeline sizing, boundary variables such as flow rates and pressures and control variables such as choke valve positions. Typical flow assurance studies include pipeline sizing studies, operating envelope studies, slugging studies, hydrate management studies, system cool down studies and system restart studies.

The process starts with the generation of a template input file (1) where the following elements are identified: network configuration, simulation restart information, fluid characterization files, the variables that are to be varied for the study and the variables that are to be output in order to perform post-simulation analysis. Prior to performing the study, a typical user will also desire to execute a single simulation based on the template in order to ensure that all the input variations and the input file itself has been correctly generated before submitting all the variations of the template for simulation (2). Once the verification step is completed, then all variations of the template file required for the study are generated (3) and a command-line batch file is prepared that sequentially executes each input file using the appropriate simulator program (4).

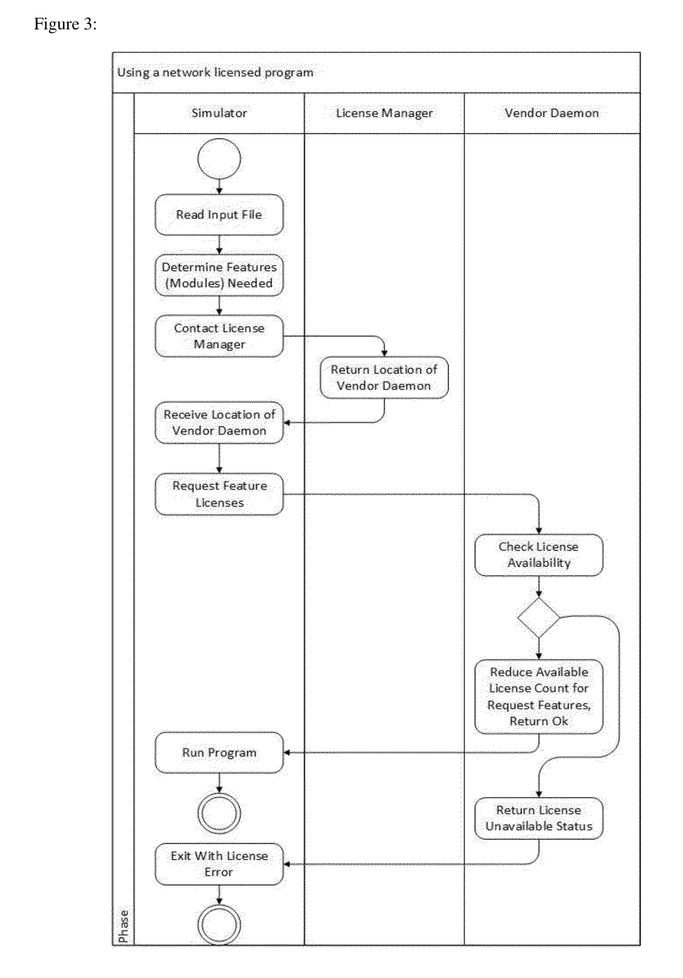

Once the batch file is launched, the simulator program is launched successively with each input file. When the simulator program is launched, it reads the input file to determine the features (or modules) required to execute the simulation. Then the simulator uses application programming interfaces provided by network license manager to check out the required licenses as illustrated in FIG. 3 according to prior art. If in this process, the license manager responds with a license unavailable status, the simulator immediately exits and the batch file moves on to the next input file. Since reading an input file typically does not take more than a few seconds, a failure to obtain licenses on one of the input files typically results in a substantial number or all of the remaining input files to fail for the same reason. The simulator may fail prior to starting the simulation for other reasons including input file syntax errors, and inability to locate or access other files referenced in the input file, such as initial conditions file or thermodynamic property table files. Once a simulation has started, it may still fail due to numerical errors. If the simulator fails before it even starts calculations, no output files are produced. If it fails in the middle of a simulation, output files may be produced up until the point of failure.

The user has to sift through the output files produced to determine which of the input files succeeded and which ones failed (5). Then the reason for the failure has to be determined (6). If the failure is caused by incorrect syntax or numerical problems, the erroneous input files then have to be adjusted to fix the problem (7). Then a new batch operation has to be started with just the failed input files and the process repeats starting from step (4). If step (2) is skipped, then the likelihood of failure is higher whereas if (2) is completed, the failures are typically only caused by numerical errors. In either case, it is a non-trivial exercise to check the results and determine which simulations, if any, need to be re-run/re-executed. Once all cases have executed successfully, the user performs post-processing of the results (9) and draws conclusions for the study (10).

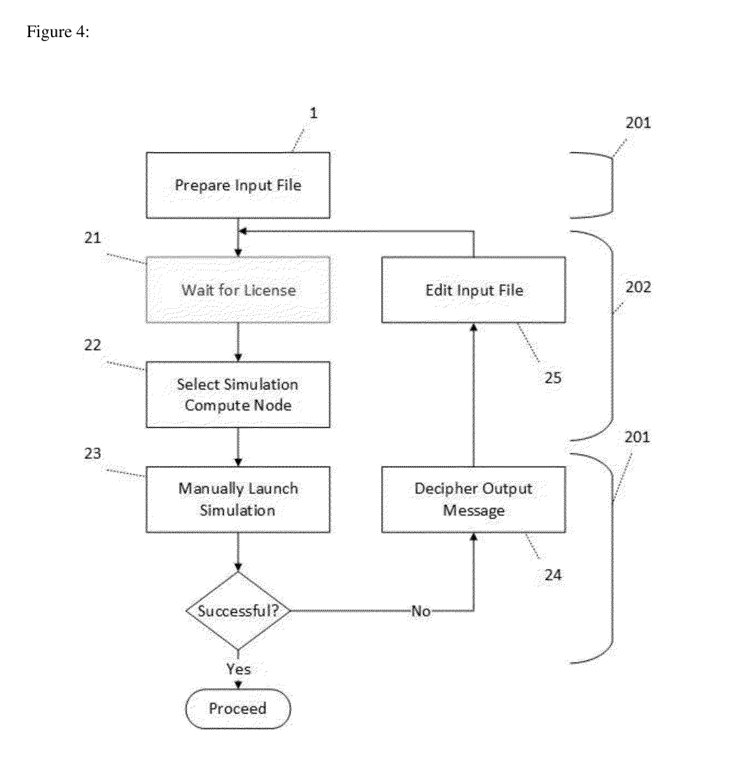

Reference is invited to FIG. 4 that illustrates the steps involved in performing step (2) with reference to FIG. 1. That is, the debug workflow according to the prior art. First, the user needs to ensure that a license is available for them to execute validation runs (21). Then, the user selects a machine to execute the validation run on (22) and manually launches the simulation (23). The more complex the input file, the more the chance of errors. If the simulator does not have a descriptive diagnostic message for syntax errors, it might be a non-trivial and iterative exercise to debug the input files (24) and get it to execute successfully. Either the user has to check out a license permanently for a period of several hours until they have debugged their input file, or they have to wait for a free license every time an error occurs and a change is made to the input file (25) to fix the error before being able to re-run/re-execute the modified input file for validation. In addition to the waiting time for the workflow, it is important to note that the simulator computer software may be installed on remote simulation computer hardware and not on the user machines. However, the tools to build the input files may be on the users' workstation. Therefore, it is possible that the user has to perform steps (21), (22), and (25) on their workstation (202), and steps (23) and (24) on one of the dedicated simulation hardware (201).

Accordingly, the present invention provides a system that includes software program that greatly simplifies the debugging workflow (2) as illustrated in FIG. 4. Further, the system of the 360 present invention includes a web-based computer software program and methods embodied in that program that greatly simplify the steps (4) through (8) as illustrated in FIG. 2.

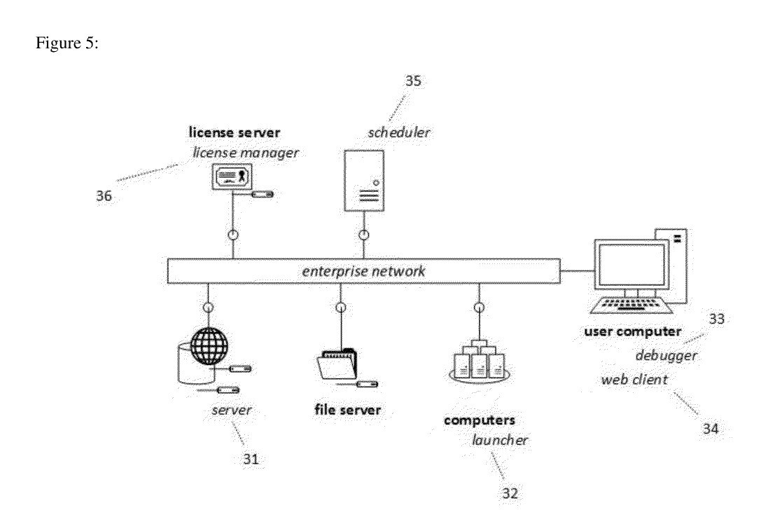

Referring to FIG. 5, the system of the present invention comprises of a database server (31), a web-based user interface that embodies specific workflows that make sense to flow assurance engineers, a simulator, a batch simulation scheduler (35) that schedules the simulation software on computing resources with specific input files based on the user-submitted information in the database, a license monitor (36) that updates the database with the number of available licenses for each feature or module, a launcher (32) running on the computing resources that monitors the database for instructions from the scheduler to launch simulations, a wrapper that contains simulator-specific information about how to launch a simulation given an input file or a set of input files and a debugger (33) that parses the input file(s) and verifies its syntax. The web-based user interface is used for validation and submission of plurality of simulation jobs to the system.

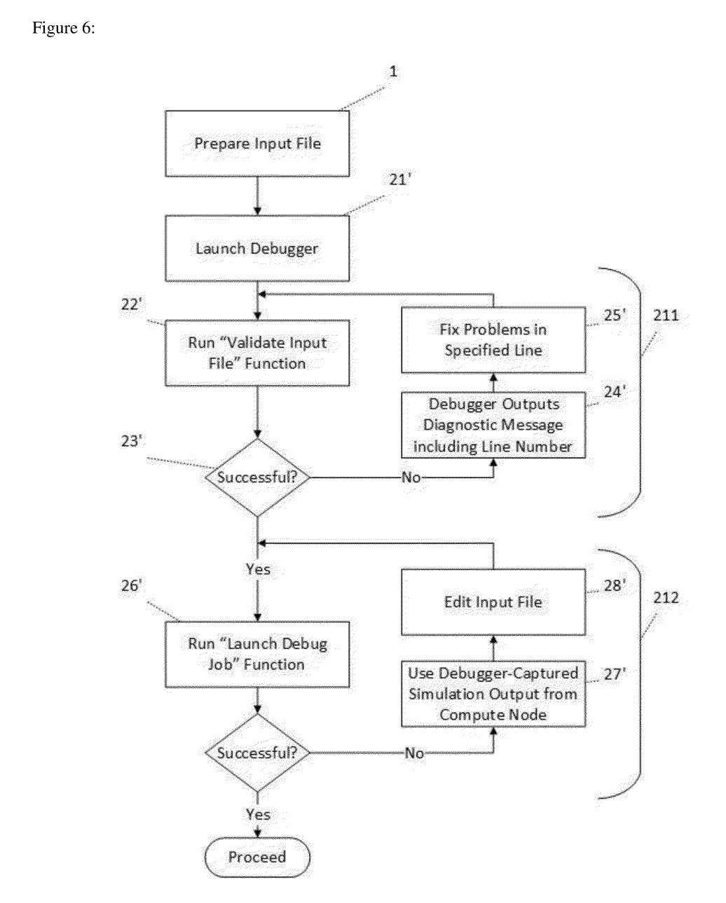

Reference is invited to FIG. 6 that illustrates the steps involved in performing step (2) with reference to FIG. 1. That is, the debug workflow according to the present invention. In the system, the debugger is a program that executes on the user's workstation and splits the debugging process into two steps. First, the debugger includes algorithms (211) that are specific to the simulation program that allow the debugger to parse an input file and verify its syntax without using a simulation license. The debugger is designed to output an error message with specific information that points the user to the exact problem (24′). Further, once the debugger is open and has checked a file, it monitors the input file for changes. Once a user fixes an error and saves the new input file (25′), the debugger automatically triggers another validation without the user having to click any button.

Once all validation checks have passed, the debugger further provides algorithms (212), wherein the user is presented the option to launch a debug simulation (26′) to check for execution-time errors, such as numerical errors described earlier. Even though the system executes the debug job on a remote machine asynchronously, the debugger monitors for the start of this debug process and once the process starts running, streams the outputs of the process back to its own display window (27′) running on the user's desktop workstation. If there are any errors at execution-time, the user can again make appropriate changes in the input file (28′) and launch a new debug job again.

The system with batch scheduling application is designed to address the needs of users that execute software with centralized, network licenses shared among one or more users. Apart from guaranteeing that simulation will never fail due to license unavailability, the system enables more efficient sharing of expensive license resource among one or more users. One immediate difference between the system jobs and command-line batch jobs is that the system will use all available licenses to execute jobs, so cases in the system jobs can potentially be executed in parallel as opposed to the sequential execution of command-line batch files.

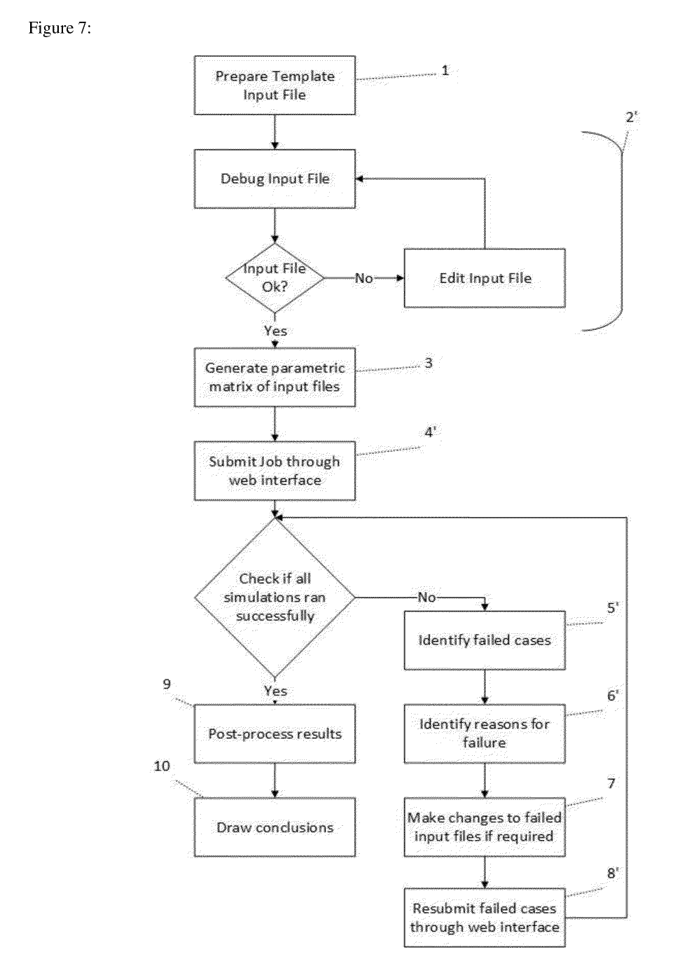

Referring to FIG. 7, after the debugger is used to debug the template input file, all the variations of the input file are generated by the user using the same process as before (3) with reference to FIG. 1. At this point, instead of creating a command-line batch file, the web interface (34) of the system is used to submit a new job to the system job queue (4′). The system allows the user to monitor the status of each individual input file, or case, in each job through the web interface. As input files are launched, the status is updated and a progress bar is shown. The system parses the outputs of the simulator to identify if the input file is executing successfully or not. At the end of all the cases in a job, the user can use filtering functionality on the job status page to quickly identify failed cases (5′). The user can also expand the status line for each of the failed cases to identify the reason for the failure (6′). After making the necessary changes to rectify the cause(s) of the failure, the user can resubmit the failed cases by clicking the “resubmit” button (8′) without having to create any new batch files or having to go through the workflow for creating a new job once again.

In addition to allowing the users to schedule flow assurance simulation jobs, the system tracks information about users' activities in its database and allows users to create custom reports that can be used for a variety of purposes. Every input file is identified by its path and modification time and one can quickly estimate how many times an input file of a particular name was modified and executed. Simulation start and end times along with the simulated time are all recorded to give the user a calculation of the speed-up achieved by the simulation. Minimum, maximum, and average times taken by cases in a job are also reported. All these metrics can be tracked by user, project, date range, modules, or any combination thereof. Reports can be used to extract exact information on license usage in order to provide clients with license usage timesheets if desired.

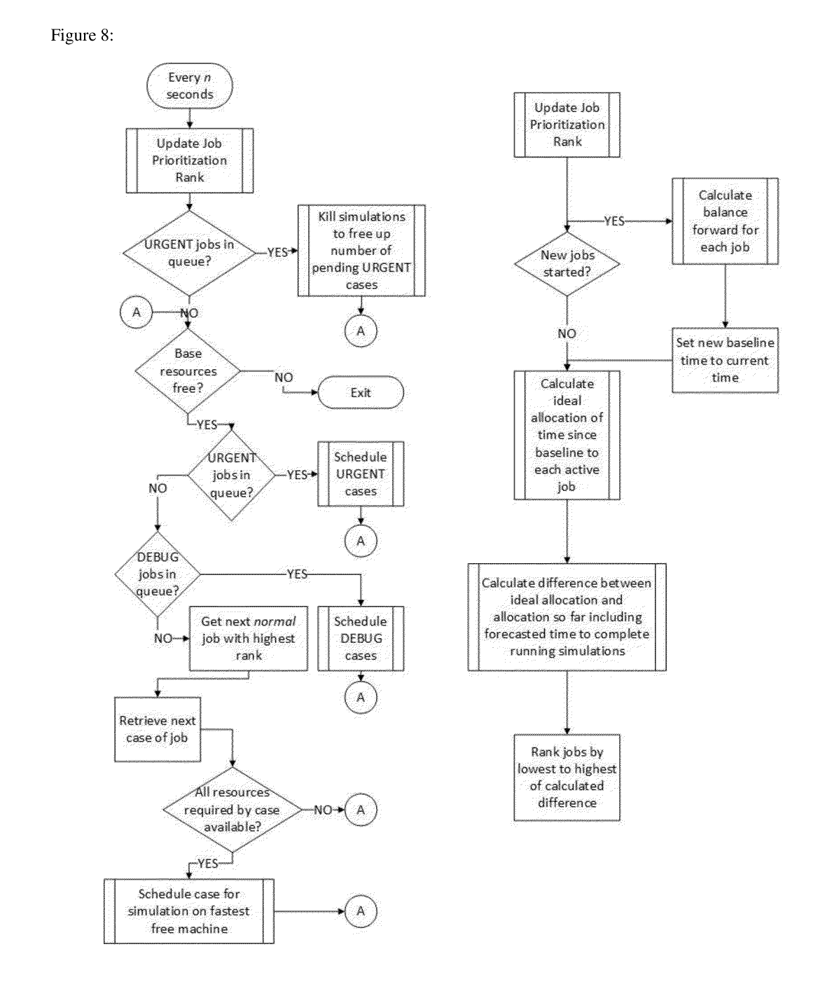

Another embodiment in the present invention is a prioritization function that fits the commercial requirements of engineering consulting function. Instead of standard prioritization algorithm/process found in computer science literature for resource scheduling, a new prioritization algorithm/process that better suits a multi-user simulation resource sharing environment is embodied in the present invention. The prioritization/process includes three (3) special priorities and three (3) normal priorities. The special priorities are urgent, debug, and background, and the three normal priorities are high, normal, and low respectively. Urgent jobs are executed as soon as they are submitted, even if it means killing currently executing simulations. The scheduler first scans for urgent jobs and as many running simulation as required to execute the cases in the urgent jobs. The cases are selected in the following manner; first, select cases that are using the licenses required by the urgent job(s), and order the cases by the time they started, latest first to the oldest last. These simulations are force-killed and added back to the queue and the cases form the urgent job queue are executed in their place. Once all urgent cases are cleared, then the scheduler scans for debug jobs. If any free licenses are available, debug jobs are executed first. Among the high, normal and low priority (i.e., normal priority) jobs, the scheduler allocates the simulation resources in the following ratio—4:2:1 (High:Normal:Low). FIG. 8 illustrates how these priority weights are calculated. When the scheduler starts, the base line time is set to the current time. Then the scheduler calculates the ideal allocation of time to each active job belonging to high, normal, and low priorities. The scheduler keeps track of the actual allocation of simulation resource to active jobs. The scheduler selects the next case to run based on a forecasted allocation of simulation resource and its proximity to the ideal allocation of simulation resource. Whenever a new job is submitted or an active job finishes, the baseline time is reset to current time and a balance forward calculation is performed. The balance forward is the difference between the ideal time allocation in the previous period (current time—previous baseline time), and the actual time allocation in the same period for each job. The scheduler calculates the balance-forward when the set of active jobs change so that relative allocation of simulation resources is always as close to the ideal allocation as possible. In the new period, the ideal allocation time is adjusted for each job by their balance forward time. If licenses are available and there are no jobs with the five priorities already discussed in the queue, then the scheduler executes cases from any background jobs. However, once a job with a higher priority is submitted, background jobs that are using a required license are immediately killed to be restarted later when again the licenses are idle. The background cases are stopped/killed by selecting the background priority cases that are using the licenses required by the other job(s); and ordering the cases based on start time in order to run other jobs.

We claim:

1. A system for efficient utilization of simulation resources comprising:
a database server;
a simulator;
a batch simulation scheduler;
a license monitor;
a launcher;
a wrapper; and
a debugger;
wherein the batch simulation scheduler schedules simulations on computing resources with specific input files based on user submitted information in database according to user-specified priorities,
wherein the license monitor updates the database with the number of available licenses for each feature or module,
wherein the launcher running on computing resources monitors the database for instructions from the scheduler to launch the simulations,
wherein the debugger parses the input file(s) and verifies its syntax without using a simulation license, and
wherein the system utilizes all available licenses to execute the jobs thereby resulting in parallel execution of cases in the jobs.

2. The system according to claim 1 schedules a plurality of simulation jobs from a plurality of users incorporating a user-selectable priority for each simulation job.

3. The system according to claim 1 tracks information about users' activities and allows the users to create custom reports to extract specific information on license usage.

4. The system according to claim 3 tracks information about users' usage of the simulation including metrics that can be used to assess the efficiency of users.

5. The system according to claim 4, wherein the metrics include cases submitted, tracking of simulation times and execution-time parameters.

6. The system according to claim 1 enables efficient sharing of expensive license resource among one or more users.

7. The system according to claim 1, wherein the wrapper contains simulator-specific information about launching a simulation.

8. A method of efficient utilization of simulation resources using the system according to claim 1 comprising the steps of:
Preparing and submitting a template input file for a simulation job;
Launching the debugger;
Debugging the template input file;
Executing a single simulation based on the template;
Generating the input files required for a parametric study;
Ensuring all input variations and the input file has been correctly generated;
Allowing the users to submit a plurality of simulation jobs;
Allowing the user to monitor the status of each individual input file or case, in each job through web-based user interface;
Launching the input files;
Parsing the outputs of the simulator to identify if the input file is executing successfully or not;
User identifying failed cases by using filtering functionality on job status page;
User identifying reasons for failed cases by expanding the status for each of the failed cases; and
Rectifying the failure and resubmitting the failed cases, and
wherein the user can resubmit the failed cases without creating any new batch files or creating a new job.

9. A method of debugging the template input files according to claim 8 comprising the steps of:
Parsing an input file and verifying its syntax through processes that are specific to simulation program without using a simulation license;
Sending an error message specific to user's exact problem;
Monitoring the input file for changes after the error being fixed by the user;
Automatically triggering another validation for changed input file without user's request;
Launching a debug simulation to check for execution-time errors;
Starting the debugging process and streaming the output of the process back to its display window; and
Allowing the user to edit the input file based on errors at execution-time and launching a new debug job again,
wherein the debugging process is executed on the user's workstation.

10. The method according to claim 9, wherein the user can estimate number of times an input file was modified and executed.

11. The method according to claim 9, wherein the user is provided with a calculation of speed-up achieved by the simulation.

12. The method according to claim 9, wherein the user is provided with minimum, maximum and average times taken by cases in a job.

13. A method of prioritization of simulation jobs for efficient utilization of simulation resources using the system according to claim 1 comprising the steps of:
Updating job prioritization, the job priorities comprising special priorities that include urgent, debug and background and normal priorities that include high, normal and low;
Checking for urgent jobs in queue;
Scanning for urgent jobs and cases required to execute the cases in the urgent jobs by the scheduler;
Selecting currently running simulations to kill to make through for urgent cases;
Force-killing the simulations and adding back to the queue;
Executing the cases from the urgent job queue;
Scanning for debug jobs after clearing the urgent cases; and
Executing the debug jobs first based on availability of free licenses.

14. The method according to claim 13, wherein the cases to stop are selected in the following manner in order to allow running urgent jobs:
Selecting the normal priority cases that are using the licenses required by the urgent job(s); and
Ordering the cases based on start time.

15. The method according to claim 13, wherein once the urgent queue is cleared the other jobs are executed in the following manner:
Scanning for debug jobs after clearing the urgent cases; and
Executing the debug jobs first based on availability of free licenses.

16. The method according to claim 13, wherein the scheduler executes background jobs when no other jobs with other priorities are in the queue.

17. The method according to claim 16, wherein background cases to stop are selected in the following manner in order to run other jobs:
Selecting background priority cases that are using the licenses required by the other job(s); and
Ordering the cases based on start time.

18. The method according to claim 13, wherein the scheduler allocates the simulation resources in the ratio 4:2:1 for the normal priorities.

19. The method according to claim 18, wherein the scheduler calculates the ideal allocation of simulation resource to jobs according to their priorities.

20. The method according to claim 18, wherein the scheduler keeps track of the actual allocation of simulation resource to active jobs.

21. The method according to claim 18, wherein the scheduler selects the next case to run based on a forecasted allocation of simulation resource and its proximity to the ideal allocation of simulation resource.

22. The method according to claim 18, wherein the scheduler calculates a balance-forward when the set of active jobs change so that relative allocation of simulation resources is always as close to the ideal allocation as possible.
